(19) United States
(12) Patent Application Publication
(10) Pub. No.: US 2012/0246877 A1
(43) Pub. Date: Oct. 4, 2012

(54) APPARATUS AND METHOD ALLOWING NEW OR EXISTING VERTICAL BLINDS TO OPPERATE FREELY FROM HORIZONTAL TO ALMOST VERTICAL

(76) Inventor: Thomas Mormino, Staten Island, NY (US)

(21) Appl. No.: 13/427,842

(22) Filed: Mar. 22, 2012

Related U.S. Application Data
(60) Provisional application No. 61/468,472, filed on Mar. 28, 2011.

(51) Int. Cl. A47H 15/00; B23P 17/04; A47H 1/04

(52) U.S. Cl. 16/94 D; 29/428

(57) ABSTRACT

An adapter can be installed between the rotational stems of a vertical blinder head rail and the vertical blind slats. The adapter enables the head rail to be mounted horizontally to almost vertically. With the adapter installed, the vertical blinds can rotate freely and open and close properly without the binding that would occur without the adapter installed. The adapter is independent of the head rail design of vertical blind systems. The adapter can be easily installed between the stems and the slats and may be packaged with a vertical blind or may be sold separately at a low cost, enabling non-horizontal installation of the head rail.

### CROSS-REFERENCE TO RELATED APPLICATIONS

This application claims the benefit of priority of U.S. provisional patent application No. 61/468,472, filed Mar. 28, 2011, the contents of which are herein incorporated by reference.

### BACKGROUND OF THE INVENTION

The present invention relates to vertical blind window treatment installation methods and apparatus and more particularly, to an apparatus and method for installing vertical blind window treatments from a horizontal configuration to a nearly vertical configuration without causing binding of the blinds.

Vertical blind window treatment assemblies are typically intended for horizontal mounting. If such an assembly is not mounted horizontally, then the slats may bind when their rotational position is adjusted.

In snow belt areas (globally), building codes require sharp roof slopes to accommodate snow loads. The sharp roof slopes often lead to triangular windows which are difficult to cover with conventional vertical blinds. Moreover, in sunbelt areas, where angular shaped cathedral ceilings are common place for maximal lighting and heat control, windows may have triangular shapes. Again, this type of window may be difficult to cover with conventional vertical blinds.

As can be seen, there is a need for a mechanism which allows new/existing vertical blind treatments to freely operate horizontally to almost vertically.

### SUMMARY OF THE INVENTION

In one aspect of the present invention, a vertical blind configuration comprises a vertical blind carrier adapted to carry a plurality of rotatable clips, the clips interfacing with the vertical blind carrier at a first end thereof; a fixed ring disposed in a fixed orientation relative to the clip; a slat hook fixed ring interconnected into the fixed ring; and a slat hook connected to the slat hook fixed ring, the slat hook adapted to hold a vertical blind slat.

In another aspect of the present invention, a vertical blind configuration comprises a vertical blind carrier adapted to carry a plurality of rotatable clips, the clips interfacing with the vertical blind carrier at a first end thereof; a fixed ring disposed in a fixed orientation relative to the clip; a slat hook fixed ring interconnected into the fixed ring; a slat hook connected to the slat hook fixed ring, the slat hook adapted to hold a vertical blind slat; and a plurality of connectors adapted to connect to the plurality of clips, wherein the connectors include the fixed ring formed integrally therewith.

In still another aspect of the present invention, a method of hanging vertical blind slats from a vertical blind carrier comprises hanging a vertical blind slat from a slat hook, the slat hook having a slat hook ring interconnected with a fixed ring that is fixed relative to a rotatable vertical blind clip.

These and other features, aspects and advantages of the present invention will become better understood with reference to the following drawings, description and claims.

### BRIEF DESCRIPTION OF THE DRAWINGS

FIG. 1 is a perspective view of a vertical blind adapter, installed on vertical blinds, according to an exemplary embodiment of the present invention;

FIG. 2 is a perspective view of the vertical blind adapter of FIG. 1, with a blind removed;

FIG. 3 is a cross sectional view taken along line 3-3 of FIG. 2;

FIG. 4 is an exploded perspective view of the vertical blind adapter of FIG. 1;

FIG. 5 is a perspective view of a vertical blind adapter, installed on a vertical blind header, according to another exemplary embodiment of the present invention;

FIG. 6 is a cross sectional view taken along line 6-6 of FIG. 5; and

FIG. 7 is an exploded perspective view of the vertical blind adapter of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an adapter that can be installed between the rotational stems of a vertical blinder head rail and the vertical blind slats. The adapter enables the head rail to be mounted horizontally to almost vertically. With the adapter installed, the vertical blinds can rotate freely and open and close properly without the binding that would occur without the adapter installed. The adapter is independent of the head rail design of vertical blind systems. The adapter can be easily installed between the stems and the slats and may be packaged with a vertical blind or may be sold separately at a low cost, enabling non-horizontal installation of the head rail.

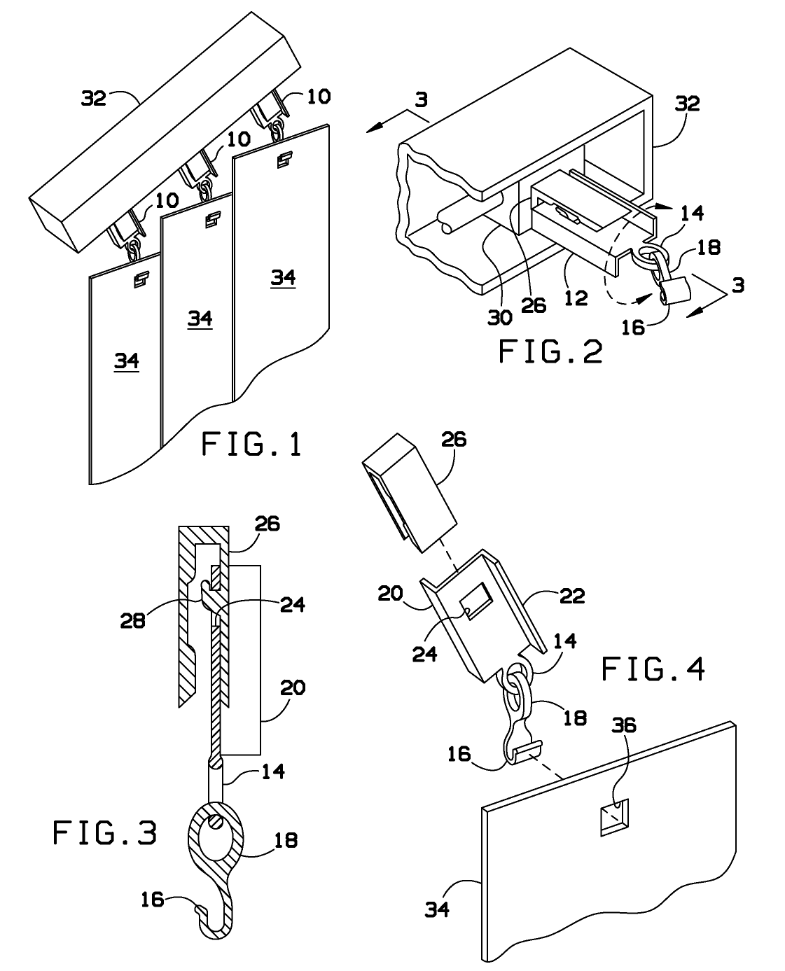

Referring to FIGS. 1 through 4, a vertical blind adapter 10 may include a connector 12 having a fixed ring 14 formed at one end thereof. The fixed ring 14 may define a plane that is substantially parallel to the plane of a vertical blind slat 34. A slat hook fixed ring 18 may loop into the fixed ring 14 of the connector 12. The slat hook fixed ring 18 may define a plane that is generally orthogonal to the plane defined by the fixed ring 14. A slat hook 16 may extend from the slat hook fixed ring 18. The slat hook 16 may be designed to hold the vertical blind slat 34 and may be designed in a variety of configurations. As shown in FIG. 4, the slat hook 16 may be a curved hook adapted to fit into a vertical blind slat notch 36 of the vertical blind slat 34.

The connector 12 may have a connector notch 24 that is adapted to fit into a vertical blind clip 26 that is connected to a vertical blind carrier 30 of a vertical blind track 32. The vertical blind clip may include a vertical blind clip hook 28 that would, without the adapter of the present invention, connect into the vertical blind slat notch 36. However, with the present invention installed, the vertical blind clip hook 26 may fit onto the connector notch 24 of the connector 12. The connector 12 may include a left raised edge 20 and a right raised edge 22. The edges 20, 22 may help secure the connector 12 onto the vertical blind clip 26. The edges 20, 22 may extend generally at 90 degree angles and extend in opposite directions on each side of the connector 12 to form a square Z-shaped cross-section. Edges 20, 22 extend in opposite directions to facilitate removal of connector 12, by sliding a thin piece of plastic which disengages notch 24 from vertical blind clip 26. In some embodiments, the edges 20, 22 may be made T shaped so that the connector 12 has a H-shaped cross-section.

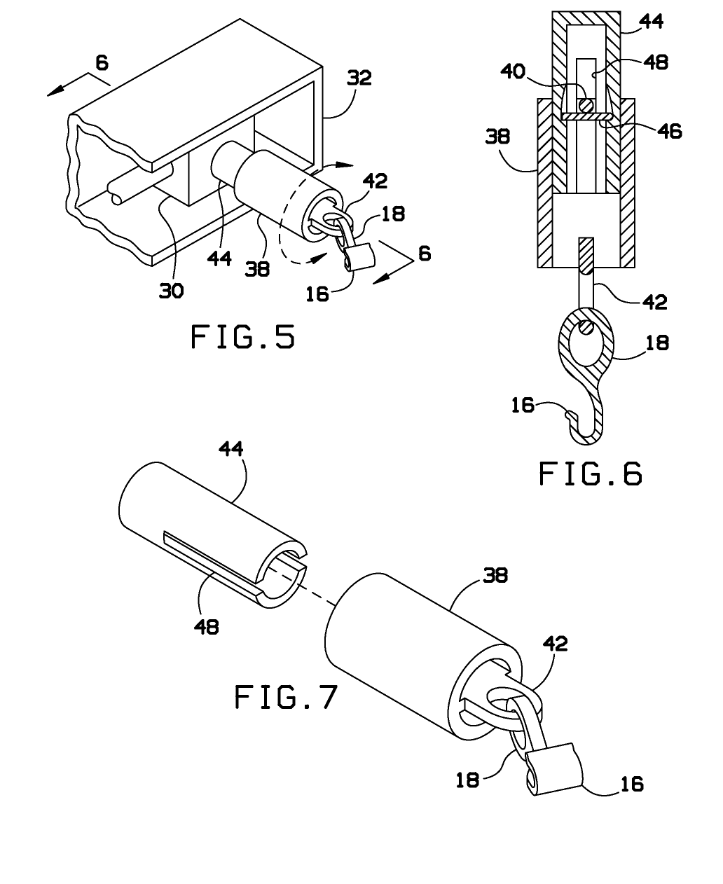

The adapter 10 may be designed to fit various types of vertical blind systems. For example, as shown in FIGS. 5 through 7, some vertical blinds may include a vertical blind cylindrical clip 44 that connects to the vertical blind carrier 30. Typically, the vertical blind cylindrical clip 44 may include a clip clot 48 cut along each side of the clip 44. Without the adapter of the present invention, this clip 44 may be used to attach vertical blind slats 34. However, with the present invention, a cylindrical connector 38 may connect to the vertical blind cylindrical clip 44 via a cylindrical connector pin 40 and a vertical blind cylindrical clip pivoting pin 46.

Similar to the connector 12 described above, the connector 38 may include a fixed ring 42 connected to the connector 38. The slat hook fixed ring 18 may interlock with the fixed ring 42 and the slat hook 16 may be connected to the slat hook fixed ring 18.

While the above description describes the fixed rings 14, 42 and the slat hook fixed ring 18 as round, other shapes may work, such as oval. One or both of the fixed rings 14, 42 and/or the slat hook fixed ring 18 may be opened as a hook, rather than interlocking circles.

While the above description shows the connectors 12, 38 as attaching to the vertical blind clips 26, 44, in some embodiments, the connectors 12, 38 may be made integral with the clips 26, 44. In other embodiments, the fixed rings 14, 42 may simply be attached to the clip 26, 44. In this embodiment, the slat hook fixed ring 18 may also be attached to the fixed rings 14, 42, resulting in a manufactured vertical blind system with the ability to operate blinds hung in a non-horizontal configuration. In still other embodiments, the fixed rings 14, 42 may connect directly to a rotatable member (vertical blind stem) on the vertical blind carrier, thereby integrating the fixed rings 14, 42 (along with interlocking slat hook rings 18) as part of the manufacturing process. These vertical blinds may then be marketed as installable at any angle, from zero to almost 90 degrees.

It should be understood, of course, that the foregoing relates to exemplary embodiments of the invention and that modifications may be made without departing from the spirit and scope of the invention as set forth in the following claims.

What is claimed is:

1. A vertical blind configuration comprising:
a vertical blind carrier adapted to carry a plurality of rotatable members, the members interfacing with the vertical blind carrier at a first end thereof;
a fixed ring disposed in a fixed orientation relative to the rotatable member;
a slat hook fixed ring interconnected into the fixed ring; and
a slat hook connected to the slat hook fixed ring, the slat hook adapted to hold a vertical blind slat.

2. The vertical blind configuration of claim 1, further comprising a plurality of connectors adapted to connect to the plurality of rotatable members, wherein the connectors include the fixed ring formed integrally therewith.

3. The vertical blind configuration of claim 2, wherein the connector includes a connector notch adapted to connect with a clip hook of the rotatable member.

4. The vertical blind configuration of claim 3, wherein the connector has a squared Z-shaped cross-section.

5. The vertical blind configuration of claim 1, wherein the fixed ring and the slat hook fixed ring are circular, interconnected rings.

6. A vertical blind configuration comprising:
a vertical blind carrier adapted to carry a plurality of rotatable clips, the clips interfacing with the vertical blind carrier at a first end thereof;
a fixed ring disposed in a fixed orientation relative to the clip;
a slat hook fixed ring interconnected into the fixed ring;
a slat hook connected to the slat hook fixed ring, the slat hook adapted to hold a vertical blind slat; and
a plurality of connectors adapted to connect to the plurality of clips, wherein the connectors include the fixed ring formed integrally therewith.

7. The vertical blind configuration of claim 6, wherein:
the connector includes a connector notch adapted to connect with a clip hook of the clip; and
the connector has a squared Z-shaped cross-section.

8. The vertical blind configuration of claim 6, wherein the fixed ring and the slat hook fixed ring are circular, interconnected rings.

9. A method of hanging vertical blind slats from a vertical blind carrier, the method comprising:
hanging a vertical blind slat from a slat hook, the slat hook having a slat hook ring interconnected with a fixed ring that is fixed relative to a rotatable vertical blind clip.

10. The method of claim 9, where the vertical blind carrier is hung in a non-horizontal orientation.
